(19) United States
(12) Patent Application Publication
(10) Pub. No.: US 2025/0324192 A1
(43) Pub. Date: Oct. 16, 2025

(54) ACOUSTIC TRANSDUCER DEVICE WITH EXPANDED BACK VOLUME

(71) Applicant: ams-OSRAM AG, Premstaetten (AT)

(72) Inventors: Jens HOFRICHTER, Horgen (CH); Goran STOJANOVIC, Rapperswil (CH); Roy DUFFY, Zurich (CH)

(21) Appl. No.: 18/866,084

(22) PCT Filed: May 25, 2023
(86) PCT No.: PCT/EP2023/064039

§ 371 Date: Nov. 15, 2024

(30) Foreign Application Priority Data
May 31, 2022 (DE) 10 2022 113 720.1

(51) Int. Cl. H04R 1/28; H04R 7/04; H04R 7/18; H04R 19/04; H04R 23/00

(52) U.S. Cl. CPC H04R 1/2807; H04R 7/04; H04R 7/18; H04R 19/04; H04R 23/008; H04R 2201/003

(57) ABSTRACT

An acoustic transducer device includes a substrate and a cap arranged on the substrate which defines an acoustic chamber as a volume between the substrate and the cap. The acoustic chamber includes a support structure disposed on the substrate; a membrane disposed on the support structure; a seal between the cap and the membrane or the support structure; a front volume defined at least by the membrane, the seal, and the cap; a primary back-volume defined at least by the membrane, the support structure, and the substrate; and a secondary back-volume. The acoustic transducer further includes a channel in the substrate or the support structure. The channel joins the primary back-volume and the secondary back-volume.

### CROSS-REFERENCE TO RELATED APPLICATIONS

This application is a US National Stage, filed under 35 U.S.C. § 371, of International Application PCT/EP2023/064039, filed May 25, 2023 and further claims priority to German Application 10 2022 113 720.1, filed on May 31, 2022, the entire content of the above-listed applications are incorporated herein by reference.

### TECHNICAL FIELD

This disclosure relates generally to an acoustic transducer device and techniques for improving signal to noise ratio (SNR) and/or frequency response of same.

### BACKGROUND

Microphones may use an electro-acoustic transducer (e.g. an acoustic transducer) to convert acoustic vibrations into an electrical signal. Microphones are widely used in a variety of electronic devices, including, but not limited to, smartphones, smartwatches, tablet computers, laptop computers, desktop computers, intemet-of-things devices, and the like. Market forces may require acoustic transducers to be manufactured with a small form factor and to generate high-quality audio signals.

The acoustic transducer may be realized with a variety of mechanisms to generate an electric signal such as relying on a capacitive signal generation, an optical signal generation, or otherwise. Particular emphasis will be placed herein on an acoustic transducer that generates an electrical signal with an optical sensor; however, nothing in this description is intended to exclude any other method for signal generation. The acoustic transducer may include a membrane, which is configured to flex or exhibit displacement in response to changes in sound pressure (e.g. in response to sound waves). The membrane may optionally include a reflective surface (e.g. a mirrored surface or a mirror), and the acoustic transducer may include a light source that is configured to direct light onto the membrane (and/or optionally onto the reflective surface) and to detect changes in the reflected light to generate a corresponding electrical signal. The acoustic transducer may be optionally configured as a micro electromechanical system (MEMS) microphone.

Acoustic transducers as disclosed herein may be generally understood as including a front volume and a back volume, as demarcated by the membrane. The front volume may generally be understood as the volume between (e.g. between and/or between and including) a housing having an acoustic port (e.g. a port for entrance of the sound wave) and the membrane. The back volume may generally be understood as the volume on the opposite side of the membrane as the front volume and which includes some or all of the sensor components (e.g. components of the optical sensor).

As a general concept, it may be desirable to design the acoustic transducer to have a high SNR. One technique for increasing the SNR is to reduce (e.g. minimize) the front volume while increasing (e.g. maximizing) the back volume. Various efforts to improve the SNR by reducing the front volume and increasing the back volume have been disclosed in at least the following.

Lim et al., US 2020/0245078 A1 discloses hollowing out the substrate beneath the membrane. This hollowed out area functionally expands the back volume.

Ginnerup et al., US 2018/0302725 A1 discloses the use of a seal to define the front volume and a sound path generated by the creation of a gap between an integrated circuit and the substrate to enlarge the back volume.

Yang, SU 9,002,040 B2 discloses arranging the membrane atop a wide structure and hollowing out the adjacent substrate to enlarge the back volume.

### BRIEF DESCRIPTION OF THE DRAWINGS

In the drawings, like reference characters generally refer to the same parts throughout the different views. The drawings are not necessarily to scale, emphasis instead generally being placed upon illustrating the present disclosure. The dimensions of the various features or elements may be arbitrarily principles expanded or reduced for clarity. In the following description, various aspects of the present disclosure are described with reference to the following drawings, in which:

FIG. 1 depicts an acoustic transducer device 100, according to a first aspect of the disclosure;

FIG. 2 depicts the acoustic transducer device according to a second aspect of the disclosure;

FIG. 3 depicts the acoustic transducer device according to a third aspect of the disclosure;

FIG. 4 depicts the acoustic transducer device according to a fourth aspect of the disclosure;

FIG. 5 depicts the acoustic transducer device having its photodiode in a cavity in the substrate;

FIG. 6 depicts the acoustic transducer device using one or more through-silicon vias (TSVs);

FIG. 7 depicts a cross-section of the acoustic transducer device;

FIG. 8 depicts the acoustic transducer device having a channel in the support structure;

FIG. 9 depicts the acoustic transducer device in which the secondary back volume is built into the cap; and

FIG. 10 depicts the acoustic transducer device in which the secondary back volume is built into the cap.

### DETAILED DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [. . . ], etc.). The phrase “at least one of with regard to a group of elements may be used herein to mean at least one element from the group consisting of the elements. For example, the phrase “at least one of with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [. . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The present disclosure relates to an acoustic transducer device with low acoustic noise, membrane high compliance (e.g. sensitivity) and high resonant frequency of the system (e,g, the package together with the membrane). The present disclosure seeks at least to provide a high signal-to-noise-ratio (SNR) in an acoustic transducer device (e.g. such as a front-port microphone) with excellent frequency response, where existing concepts fail. As described above, other acoustic transducer devices may attempt to counteract low SNR by increasing back-volume within the membrane die. The current disclosure instead reduces the front volume through an acoustic seal and expands the back volume by including a channel between a primary back volume and a secondary back volume. Otherwise stated, the current disclosure reduces acoustic noise (e.g. as is common in top port microphones) by reducing the front volume and thereby establishing a high resonant frequency; increasing the back volume to reduce acoustic noise that is dominated by thermal boundaries; and combining membrane mechanical compliance (e.g. sensitivity) with the acoustic front volume and back volume.

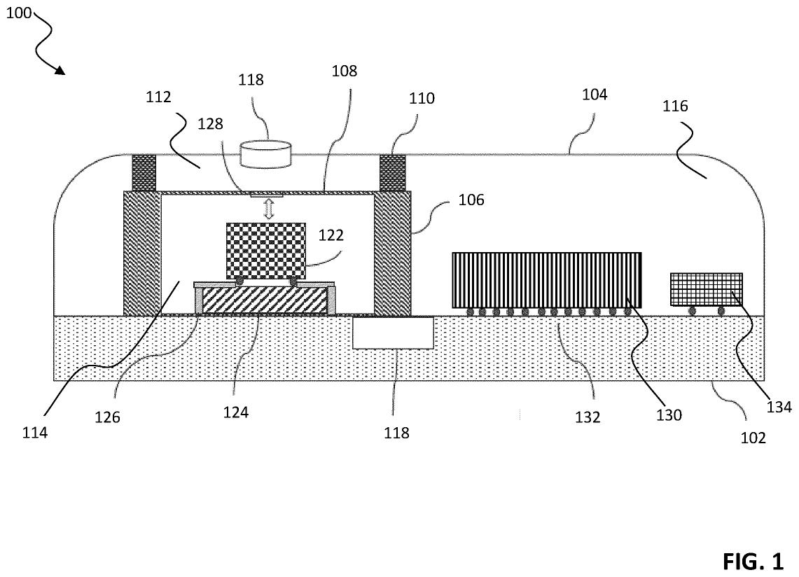

FIG. 1 depicts an acoustic transducer device 100, according to a first aspect of the disclosure. The cap 104 defines an acoustic chamber as a volume between the PCB/substrate 102 and the cap 104. The acoustic chamber includes a membrane substrate (e.g. support structure) 106, disposed on the PCB/substrate 102. The acoustic chamber includes a membrane 108, disposed on the support structure 106. The membrane 108 may become displaced in response to changes in acoustic pressure. The acoustic chamber further includes a seal 110, disposed between the cap 104 and the membrane 108 or between the cap 104 and the support structure 106. The acoustic chamber includes a front volume 112, which is defined at least by the membrane 108, the seal 110, and the cap 104. Sound waves enter the front volume 112 from an area exterior to the device, and cause displacement of the membrane 108. The acoustic chamber includes a primary back volume 114, which is defined at least by the membrane 108, the support structure 106, and the PCB/substrate 102. The primary back volume 114 is separated from the front volume 112 by the membrane 108. The acoustic chamber further includes a secondary back-volume 116, different from the front volume 112 or the primary back volume 114. The primary back volume 114 and the secondary back volume 116 are connected by a channel 118 in the PCB/substrate 102 or the support structure 106, wherein the channel 118 joins the primary back volume 114 and the secondary back volume 116. The acoustic chamber may define acoustic compliance of the acoustic transducer.

The acoustic transducer device may further include an acoustic port 120, which may be configured as an opening within the cap 104. The acoustic port 120 may be positioned to create an opening between a space outside of the acoustic device 100 and the front volume 112, for example, for sound waves to travel into the front volume 112. The acoustic port 120 may be created with any size to accommodate the needs of the given implementation for the acoustic transducer. In acoustic port 120 may be centered relative to the membrane 108. Alternatively, the acoustic port 120 may be off-center relative to the membrane 108. In some configurations, it may be desirable to place the acoustic port 120 off-center relative to the membrane, such as to improve eye-safety (e.g. to avoid the light source laser emanating from the acoustic port, such as in a membrane failure). In one non-limiting example, the acoustic port 120 may be less than 2 mm in diameter; in another non-limiting example, the acoustic port 120 may be less than 1 mm in diameter; non-limiting example, the acoustic port 120 may be less than 0.5 mm in diameter; non-limiting example, the acoustic port 120 may be approximately 0.3 mm in diameter. Alternatively or additionally, the acoustic transducer device may include a plurality of smaller diameter sound ports. Such ports may be, for example, 0.3 mm of smaller.

The acoustic transducer device includes a sensor, which is configured to generate an electrical signal representing the sound wave within the acoustic chamber. Although various sensor types (e.g. capacitive, optical, etc.) may be used in the acoustic transducer disclosed herein, the following will describe the acoustic transducer having a light source and an optical sensor (e.g. a photodiode). As stated above, the acoustic transducer may include a light source 122, which may be configured to generate light (e.g. generate electromagnetic wavelengths in the visible spectrum and/or invisible spectrum, optionally including infrared wavelengths and/or ultraviolet wavelengths). An exemplary configuration of the light source 122 may be a vertical cavity surface emitting laser (VCSEL). The light source 122 (e.g. the VCSEL) may be configured to direct light into the membrane 108. Changes in the flexion (e.g. displacement of the membrane) of the membrane 108 due to changes in acoustic pressure will result in changes of the reflection of the light off the membrane 108. The acoustic transducer device may include a photodiode/a photodiode chip 124, which may be configured to detect light generated by the light source 122 and reflected off the membrane 108, and to generate an electrical signal based on these detected light. In an optional configuration, the membrane may include a mirror 128 or other reflective surface, disposed on a second side of the membrane (e.g. on a side within the primary back volume), which may increase the amount of light reflected off the surface of the membrane. Alternatively, the membrane may be configured without a mirror, in which case the light generated by the light source 122 may simply be reflected by the material of the membrane. Although the membrane itself may be less reflective than a mirror, the acoustic transducer may be operated without a mirror. Should a mirror be used, a diameter of the mirror should generally be smaller than the membrane diameter. In an optional configuration, the diameter of the mirror may be between 10 pm and 120 pm; for example, the diameter is approximately 100 microns.

The acoustic transducer device may include a metallization layer 126.

The acoustic transducer device may include an integrated circuit 130. The integrated circuit 130 may be optionally attached to the PCB/substrate 102 using a digital die attach 132, such as, for example, a flipchip connection, or a wire bonding.

The acoustic transducer device may include one or more surface mounted devices 134. The one or more surface mounted devices 134 may include one or more electrical components including, but not limited to, ohmic resistors, inductors, capacitors, transistors, or otherwise. The one or more surface mounted devices 134 may be configured to alter a current or a voltage of an electrical signal within the acoustic transducer.

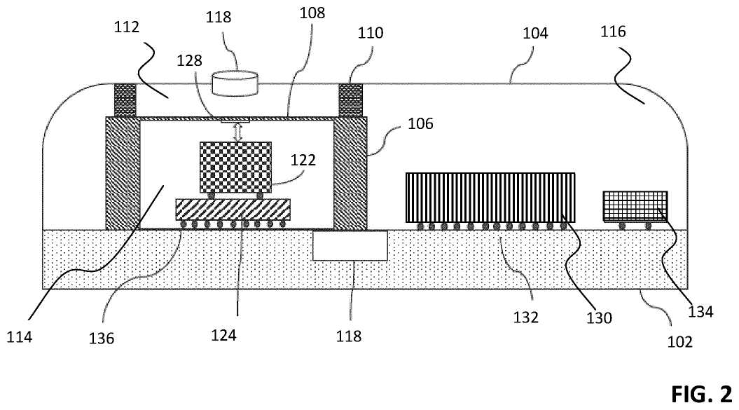

FIG. 2 depicts the acoustic transducer according to a second aspect of the disclosure. In this configuration, each element of the acoustic transducer of FIG. 2 is identical to the corresponding elements in FIG. 1, except that a solder ball array 136 may be present, wherein the solder ball array may electrically conductively connect the photodiode/photodiode chip 124 to the metallization layer 126.

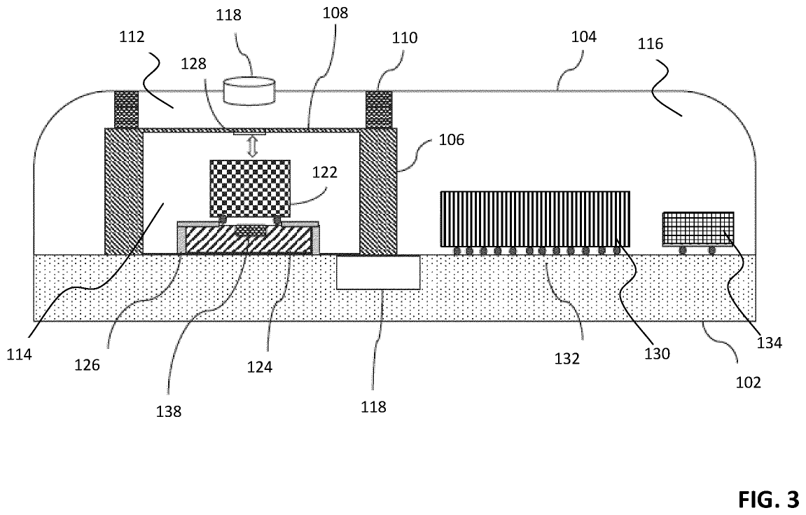

FIG. 3 depicts the acoustic transducer according to a third aspect of the disclosure. In this configuration, each element of the acoustic transducer of FIG. 3 is identical to the corresponding elements in FIG. 1, except that the photodiode chip 124 may be configured with an integrated photodiode 138.

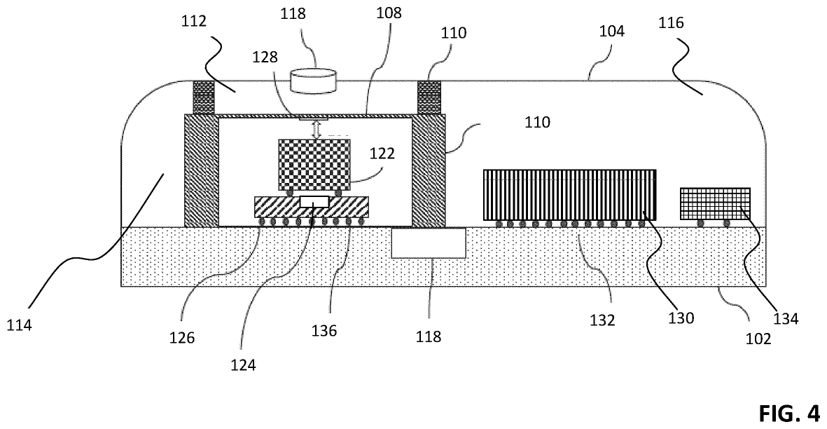

FIG. 4 depicts the acoustic transducer according to a fourth aspect of the disclosure. In this configuration, the solder ball array 136 and the integrated photodiode 124 are each present.

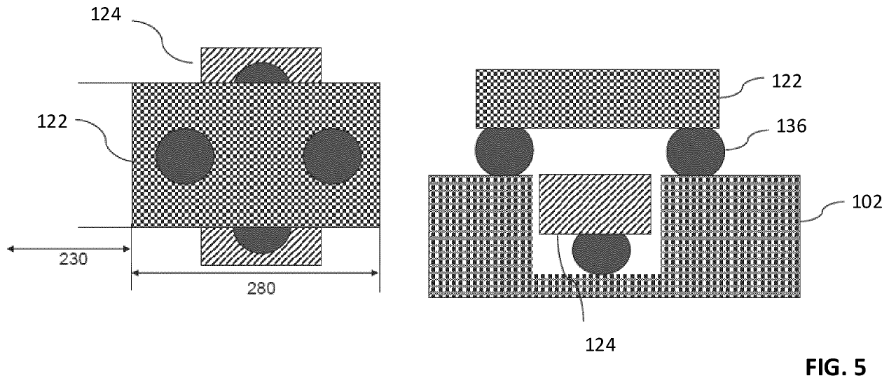

FIG. 5 depicts the subject matter of any of the acoustic transducers in FIGS. 1-4, in which a cavity is formed in the PCB/substrate 102, and the photodiode/photodiode chip 124 is placed within the cavity. In this configuration, the light source 122 may be placed on the PCB/substrate 102, such as above the photodiode/photodiode chip 124.

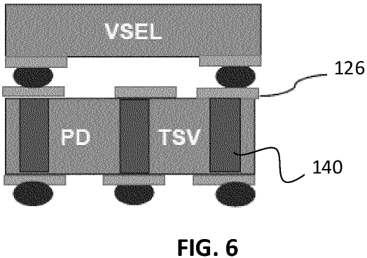

FIG. 6 depicts the subject matter of FIGS. 1-4, in which one or more through-silicon vias (TSVs) 140 are used to connect a metallization layer 126 at the top of the photodiode to a metallization layer (not labeled) at the bottom of the photodiode.

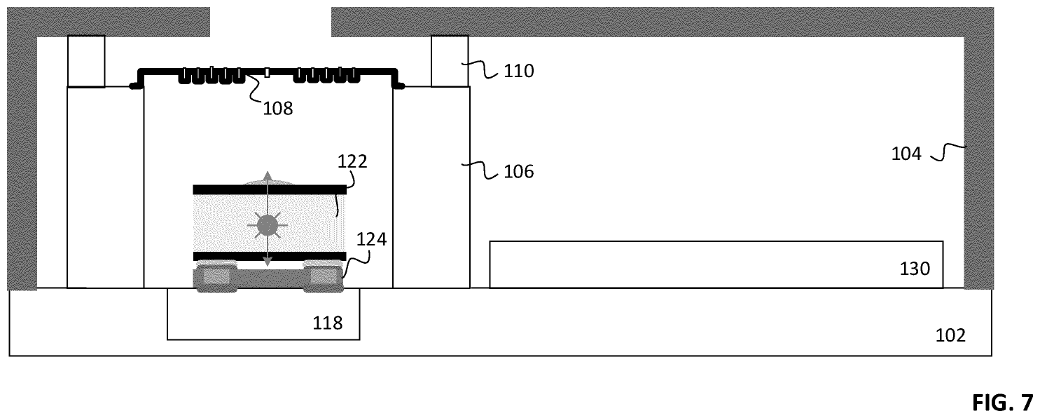

FIG. 7 depicts a cross-section of the acoustic transducer in any of FIGS. 1-6. In this figure, a cap 104 is placed on the substrate 102 and defines an acoustic chamber. The support structure 106 is arranged on the substrate 102, and a membrane 108 is arranged on the support structure 106. A seal 110 is arranged between the support structure and/or the membrane 108 and the cap 104 and thus defines a front volume as the volume between the cap 104, the membrane 108, and the seal 110. On the other side of the membrane 108, a primary back volume is defined by the volume between the support structure 106, the membrane 108, and the substrate 102. The primary back volume includes a light source 122 and a photodiode/photodiode chip 124. Within the primary back volume, the substrate includes a channel 118, which connects the primary back volume to a secondary back volume. In this figure, the channel 118 is depicted as being across an axis within a same plane as, but perpendicular to, a primary length of the substrate. Otherwise stated, the support structure 106 includes four walls to form an enclosed structure (e.g. defined by the four walls, the substrate, and the membrane). Alternatively, the support structure 106 may include any number of walls provided that an enclosed structure is forms between the wall(s) of the support structure, the membrane, and the substrate. The channel may be created in the substrate beneath one or more wall(s) of the support structure 106. In FIG. 7, the wall underneath which the channel is formed is not shown, as FIG. 7 is a cross-section, and the wall under which the channel is formed is located on a plane other than the plane that forms the basis of this crosssection.

In an optional configuration, a height of the seal 110 (e.g. a distance along the seal between the cap and the support structure) may be less than 0.5 mm, e.g. less than 0.2 mm. In an optional aspect of the disclosure, the height of the seal may be approximately 0.1 mm.

In an optional configuration, a height of the support structure 106 may be less than 1 mm, and e.g. less than 0.8 mm. In an optional aspect of the disclosure, the height of the support structure may be approximately 0.65 mm. The support structure 106 may optionally be made with multiple layers, e.g. multiple layers of the same material. Such layering of materials may be more cost effective than etching thicker substrates (e.g. substrates thicker than 0.65 mm).

In an optional configuration, an outer dimension of the support structure 106 (e.g. a length or width from exterior wall surface to exterior wall surface) may be less than 2 mm, e.g. less than 1.6 mm. According to an optional aspect of the disclosure, the outer dimension may be approximately 1.4 mm by 1.4 mm. In this these optional aspects, an inner dimension of the support structure 106 (e.g. from inner wall surface to inner wall surface) may be less than 1.5 mm, or e.g. less than 1.3 mm. In an optional aspect, the inner dimension of the support structure may be approximately 1 mm, approximately 1.1 mm, or approximately 1.2 mm.

According to an optional aspect of the disclosure, the photodiode/photodiode chip 124 and the light source 122 together may be less than 1.0 mm high, e.g. less than 0.7 mm. According to an optional aspect of the disclosure, the height of the photodiode/photodiode chip 124 and the light source 122 together may be approximately 0.45 mm.

According to an optional aspect of the disclosure, the channel 118 may be less than 2.0 mm wide, e.g. less than 1.0 mm wide, e.g. a maximum of 0.9 mm wide. According to an optional aspect of the disclosure, the channel 118 may be a minimum of0.05.

According to an optional aspect of the disclosure, the membrane may be greater than 0.5 mm wide, e.g. at least 1.0 mm wide, e.g. in a range from about 1.0 mm to about 1.2 mm wide.

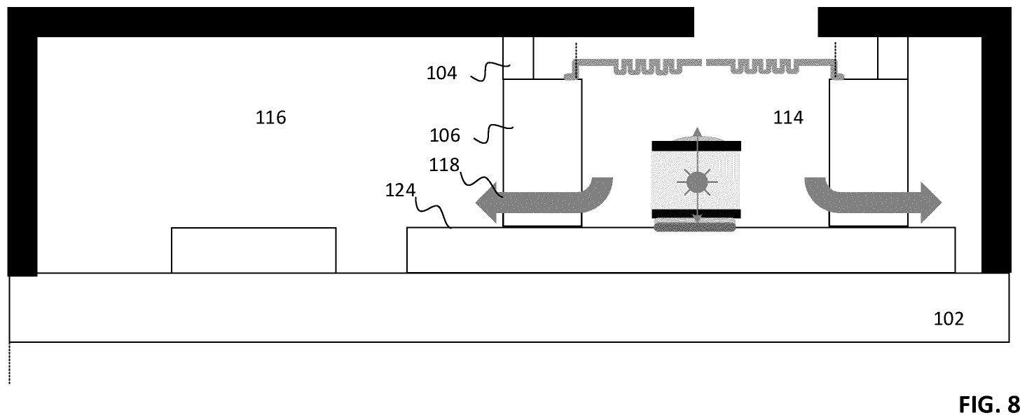

FIG. 8 depicts the acoustic transducer, in which the channel is created in the support structure 106 rather than in the substrate 102. In this manner, a channel (e.g. the opening) is created in the vertical walls of the support structure 106, which allows for air communication between the primary back volume 114 and the secondary back volume 116. The air communication is represented by the arrows along the channel 118. In an optional aspect of the disclosure, when creating the channel in the support structure 106, the substrate may remain intact (e.g., without a channel).

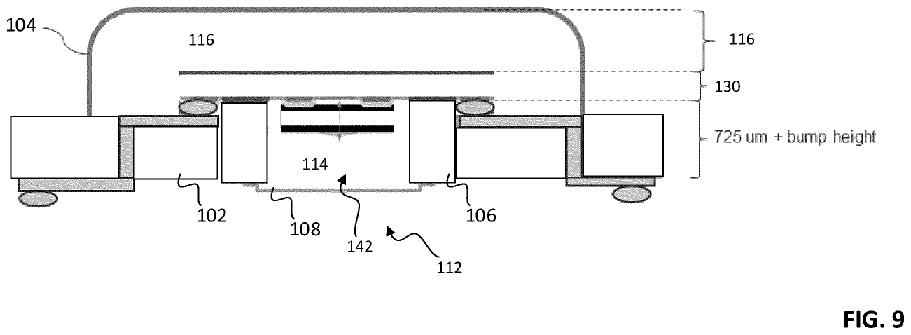

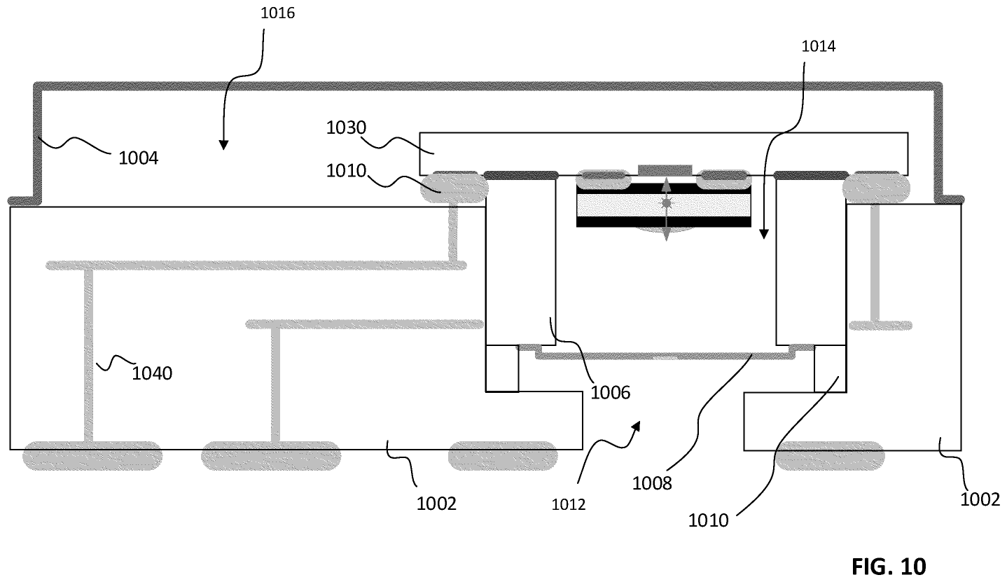

FIG. 9 depicts an optional alternative configuration in which the secondary back volume is built into the cap. In this configuration, the acoustic transducer device may include a substrate 102, including a recess 142 (corresponding to the primary back volume 114); a chip 130, arranged over the recess, and including a first side, facing toward the recess, and a second side, opposite the first side, and defining an acoustic chamber as a volume between the recess and the chip; and a cap 104, arranged on the substrate 102 and over the chip 130, wherein the acoustic chamber includes a support structure 106, disposed in the recess, on the first side of the chip; and a membrane 108, disposed on the support structure 106; a primary back-volume 114 defined at least by the membrane, the support structure, and the chip; and a secondary back-volume 116, defined at least by the cap, the substrate, and the chip, and different from the primary back-volume 114; further including a channel in the substrate or the support structure, wherein the channel joins the primary back-volume 114 and the secondary back-volume 116. FIG. 10 depicts a further optional alternative configuration in which the secondary back volume is built into the cap. In this optional alternative configuration, the acoustic transducer device includes a substrate 1002, including a recess (e.g. the recessed area within 1002); a chip 1030, arranged over the recess, and including a first side, facing toward the recess, and a second side, opposite the first side, and defining an acoustic chamber as a volume between the recess and the chip; and a cap 1004, arranged on the substrate 1002 and over the chip 1030, wherein the acoustic chamber includes a support structure 1006, disposed in the recess, on the first side of the chip; and a membrane 1008, disposed on the support structure; a seal 1010, disposed in the recess on the membrane or the support structure; a front volume 1012, defined at least by the membrane, the seal, and the recess; and a primary back-volume 1014, defined at least by the membrane, the support structure, and the chip; and 1016 a secondary back-volume, defined at least by the cap, the substrate, and the chip, and different from the front volume or the primary back-volume; further including a channel in the substrate or the support structure, wherein the channel joins the primary back-volume and the secondary back-volume.

As described above, the acoustic transducer includes a channel between the primary back volume and the secondary back volume. This channel permits air communication between the primary back volume and the secondary back volume and effectively renders the primary back volume and the secondary back volume a singular back volume that is larger than the primary back volume alone. As such, the opening increases the size of volume, which yields a higher SNR and improves frequency response.

Various configurations of the channel are possible. According to one aspect, the channel may be a trench in the PCB/substrate. This channel may be arranged, for example, beneath the support structure. According to another aspect, the channel may be located within the support structure, rather than in the PCB/substrate. Whether the channel is located in the PCB/substrate or in the support structure may be selected based on manufacturing requirements, materials used, or otherwise as desired.

The channel may be made in any of a variety of shapes. The channel may optionally be made such that a cross-section of the channel is rectangular, square, triangular, or any combination thereof. Alternatively or additionally, the channel may optionally be made to have a cross-section in an irregular polygon shape. The channel may be made in any height, for example, the channel may be at least 50 pm high.

The acoustic resistance is at least partially determined by the opening of the channel—by the profile of the channel and the length of the channel. The channel height may greatly influence the acoustic resistance, and therefore a channel height of at least 50 pm may be provided. The channel width may be selected based on other factors, such as, for example, the membrane die size. In many instances, it may be desirable to design the channel width to be and as large as possible.

The acoustic transducer device includes a cap, which covers the substrate and may define the acoustic chamber, including the front volume, the primary back volume, and the secondary back volume. In some configurations, the cap includes an opening, which is configured to allow sound waves to pass from outside the acoustic chamber into the front volume.

The acoustic transducer includes a membrane, which is configured to become displaced (e.g. exhibit movement or flexion) in response to the sound waves in the front volume. The membrane may include a first side and a second side, wherein the first side faces the cap, and wherein the second side faces the substrate. The membrane may be arranged on the support structure. The membrane may demarcate the front volume from the primary back volume. The membrane may optionally have a diameter of 100 pm to 2000 pm.

The acoustic transducer device includes a seal, which in combination with the membrane and support structure may seal the front volume to prevent or limit movement of air from the front volume into the primary back-volume or the secondary back-volume.

The acoustic transducer device may include a mirror, arranged on the second side of the membrane. In an alternative configuration, the mirror may be manufactured between the first side and the second side of the membrane. The mirror may be or include any reflective material, which may e.g. include gold and/or aluminum. The mirror may be deposited on the second side of the membrane using any deposition process. The mirror may increase reflectivity of the second side of the membrane such that a greater amount of light is reflected from the membrane to the photodiode/photodiode chip. According to an aspect of the disclosure, a diameter of the mirror (e.g. in the case that the mirror is used) may be less than 120 pm, e.g. less than 80 pm, e.g. less than 50 pm. The diameter of the mirror may optionally be in the range from about 10 pm to about 120 pm.

Alternatively, the acoustic transducer may omit the mirror on the second side of the membrane. When the acoustic transducer is implemented without the mirror, the light source is configured to direct light to the second surface of the membrane, and photodiode/photodiode chip is configured to detect light that reflects from the second surface of the membrane without the mirror. Although the non-mirrored surface of the membrane is expected to reflect less light than a mirrored surface, the membrane's surface nevertheless exhibits some amount of reflectivity and this amount is often sufficient to detect the reflected light and generate a corresponding electrical signal.

The membrane may include one or more openings, which may be present to permit static pressure equalization between the front volume and the back volume. Such opening or openings may allow at least limited transfer of air between the front volume and the primary back volume. Such opening(s) may be, for example 6 pm or less. In another example, the opening(s) may be 3 pm to 6 pm. In the case of no opening, a further opening for pressure equalization may be alternatively created in the cap or the substrate.

Various elements of the acoustic transducer may be located in the back volume, for example, the primary back volume. These may include the light source, which may be a VCSEL and a photodiode/a photodiode chip.

The light source may be configured to direct light onto the second side of the membrane. The light source may be a VCSEL, although other light sources may be used. VCSELs are known and thus the details of VCSELs or their creation will not be recounted herein. As VCSELs emit light normal to the VCSEL, the VCSEL may be placed or formed essentially parallel to the PCB/substrate beneath the membrane, such that an emission of light normal to the PCB/substrate results in an emission of light directed to the membrane. In this manner, the VCSEL may have a line of sight connection to the mirror or the second side of the membrane.

The acoustic transducer device further includes an optical sensor, which is configured to detect light reflected from the membrane (e.g. from the second surface of the membrane or from the mirror applied to the second surface) and to generate an electrical signal corresponding to the detected light. The particular type of optical sensor may be selected for a given implementation, without limitation. Possibilities for optical sensors include, but are not limited to, photoconductive devices, which may be configured to generate a change in resistance in response to incident light; photovoltaics, which may be configured to generate a voltage in response to incident light; photodiodes or phototransistors, which may be used to generate an output current in response to incident light. The terms “photodiode”, “photodiode chip”, and “integrated photodiode” are used herein as a non-limiting list of types of optical sensors.

In certain configurations, the acoustic transducer device may include a tertiary back-volume, which may be different from the front volume, the primary back-volume, and the secondary back-volume. In this configuration, the channel as described above is a first channel, and the acoustic transducer device also includes a second channel, which is configured to join the primary back-volume and the tertiary back-volume. In this manner, an additional back volume is added to the primary back volume.

In an optional configuration, the membrane may include one or more holes. These one or more holes may be referred to as “venting holes” or “pressure equalization holes” and may balance pressure at low frequencies and improve robustness. By use of these optional holes, the acoustic transducer device may be configured such that the high-pass cut off frequency is smaller than 20 Hz. The number and diameter of the holes may be selected such that the equivalent acoustic resistance is as high as possible, i.e. larger than 1 e 15 N/m³. Those parameters may depend on the number, position and diameter of the pressure equalization holes. In various aspects of this disclosure, two or more holes with diameters of 3 pm may be used, and these may be located at the vicinity of the larger DRIE hole forming the primary back-volume. Each of the optional one or more holes in the membrane may be at least 2 pm in diameter. In a non-limiting example, each of the optional one or more holes in the membrane may be no more than 10 pm in diameter. In a non-limiting example, each of the optional one or more holes may be approximately 3 pm in diameter. The material of the membrane may be selected for the given implementation without restriction; however, in a non-limiting example, the membrane may contain or include Silicon Nitride (SiN) and/or Poly-crystalline Silicon (Poly Si). The membrane may be optionally generated by plasma-enhanced chemical vapor deposition, low-pressure chemical vapor deposition, a Silane-based coating application, or a physical vapor deposition (PVD), such as sputtering.

As stated above, although the acoustic transducer device disclosed herein may be configured as an optical microphone. Of note, optical microphones may lack a backplate, but instead have a line of sight between the laser (e.g. a VCSEL) and the membrane, which may optionally include a mirror. The membrane may be flat or corrugated and might include a raised microstructure. In various aspects of this disclosure, the membrane has a diameter between 500 and 1500 pm. The membrane shall not be smaller than e.g. 100 micron and shall not be larger than 2000 pm.

The material for the seal may be selected for the given implementation, without restriction; however, in a non-limiting example, the seal may contain or include silicone, an ultraviolet curable epoxy, a thermally curable epoxy, or any of these. A material may be selected on the basis of it providing a good acoustic seal with low bleeding towards the edges. Contamination of the membrane by the seal, and therefore degradation of the membrane's performance, should be prevented. The material for the seal may ideally be rapidly curable.

In a non-limiting example, the acoustic transducer device of any aspect of the disclosure and/or any aspect disclosed herein may be configured as a micro electromechanical microphone.

Additional aspects of the disclosure will be shown by way of example.

In Example 1, an acoustic transducer device including: a substrate; and a cap, arranged on the substrate, and defining an acoustic chamber as a volume between the substrate and the cap; wherein the acoustic chamber includes: a support structure, disposed on the substrate; and a membrane, disposed on the support structure; a seal, disposed between the cap and the membrane or the support structure; a front volume defined at least by the membrane, the seal, and the cap; and a primary back-volume defined at least by the membrane, the support structure, and the substrate; and a secondary back-volume, different from the front volume or the primary back-volume; further including a channel in the substrate or the support structure, wherein the channel joins the primary back-volume and the secondary back-volume.

In Example 1, the acoustic transducer device of Example 1, wherein the channel is a trench, and the trench is in the substrate.

In Example 2, the acoustic transducer device of Example 2, wherein the channel is a trench, and the trench is in the substrate, beneath the support structure.

In Example 3, the acoustic transducer device of Example 1, wherein the channel is in the support structure.

In Example 4, the acoustic transducer device of any one of Examples 1 to 4, wherein the channel is at least 50 pm high.

In Example 5, the acoustic transducer device of any one of Examples 1 to 5, wherein a cross-section of the channel is rectangular, square, triangular, or any combination thereof.

In Example 6, the acoustic transducer device of any one of Examples 1 to 6, wherein the cap includes an opening, configured to allow sound waves to pass from outside the acoustic chamber into the front volume; and wherein the membrane is configured to displace in response to the sound waves in the front volume. In an optional configuration, the cap may include a plurality of such openings, wherein a diameter of each opening is 50 pm to 300 pm.

In Example 7, the acoustic transducer device of Example 7, wherein the primary back-volume includes a transducer, configured to generate an electrical signal based on the displacement of the membrane.

In Example 8, the acoustic transducer device of Example 8, wherein the transducer includes an optical sensor.

In Example 9, the acoustic transducer device of any one of Examples 1 to 9, wherein the membrane includes a first side, facing the cap, and a second side, facing the substrate

In Example 10, the acoustic transducer device of any one of Examples 1 to 10 wherein the electromechanical microphone further includes a mirror on the second side of the membrane.

In Example 10a, the acoustic transducer device of any one of Examples 1 to 10 wherein the electromechanical microphone further includes a mirror between the first side of the membrane and the second side of the membrane.

In Example 11, the acoustic transducer device of any one of Examples 9 to 11, wherein the transducer includes a laser.

In Example 12, the acoustic transducer device of Example 12, wherein the laser has a line of sight connection to the mirror.

In Example 13, the acoustic transducer device of any one of Examples 11 to 13, wherein the mirror includes aluminum or gold.

In Example 14, the acoustic transducer device of any one of Examples 11 to 14, wherein a diameter of the mirror is between 10 pm and 120 pm.

In Example 15, the acoustic transducer device of any one of Examples 1 to 15, wherein the membrane has a diameter of 100 pm to 2000 pm.

In Example 16, the acoustic transducer device of Example 16, wherein the membrane has a diameter of 500 pm to 1500 pm.

In Example 17, the acoustic transducer device of any one of Examples 1 to 17, wherein the front volume is sealed to prevent movement of air from the front volume into the primary back-volume or the secondary back-volume.

In Example 18, the acoustic transducer device of any one of Examples 1 to 18, wherein the acoustic chamber further includes a tertiary back-volume, different from the front volume, the primary back-volume, and the secondary back-volume; wherein the channel is a first channel; further including a second channel, configured to join the primary back-volume and the tertiary back-volume.

In Example 19, the acoustic transducer device of any one of Examples 1 to 19, wherein the membrane includes one or more holes.

In Example 20, the acoustic transducer device of Example 20, wherein each of the one or more holes are at least 2 pm and no more than 10 pm in diameter.

In Example 21, the acoustic transducer device of Example 21, wherein each of the one or more holes are approximately 3 pm in diameter.

In Example 22, the acoustic transducer device of any one of Examples 1 to 22, wherein the seal includes silicone, an ultraviolet curable epoxy, or a thermally curable epoxy.

In Example 23, the acoustic transducer device of any one of Examples 1 to 23, wherein the membrane includes Silicon Nitride (SiN) or Poly-crystalline Silicon (Poly Si).

In Example 24, the acoustic transducer device of any one of Examples 1 to 24, wherein the membrane is generated by plasma-enhanced chemical vapor deposition, low-pressure chemical vapor deposition, a Silane-based coating application, or physical vapor deposition (PVD), such as sputtering.

In Example 25, the acoustic transducer device of any one of Examples 1 to 25, wherein the acoustic chamber defines acoustic compliance of the acoustic transducer.

In Example 26, the acoustic transducer device of any one of Examples 1 to 26, wherein the acoustic transducer is configured as a micro electromechanical microphone.

In Example 27, an acoustic transducer device including: a substrate, including a recess; a chip, arranged over the recess, and including a first side, facing toward the recess, and a second side, opposite the first side, and defining an acoustic chamber as a volume between the recess and the chip; and a cap, arranged on the substrate and over the chip, wherein the acoustic chamber includes: a support structure, disposed in the recess, on the first side of the chip; and a membrane, disposed on the support structure; a seal, disposed in the recess on the membrane or the support structure; a front volume defined at least by the membrane, the seal, and the recess; and a primary back-volume defined at least by the membrane, the support structure, and the chip; and a secondary back-volume, defined at least by the cap, the substrate, and the chip, and different from the front volume or the primary back-volume; further including a channel in the substrate or the support structure, wherein the channel joins the primary back-volume and the secondary back-volume.

In Example 28, the acoustic transducer device of Example 28, wherein the channel is a trench, and the trench is in the substrate.

In Example 29, the acoustic transducer device of Example 28 or 29, wherein the channel is at least 50 pm high.

In Example 30, the acoustic transducer device of any one of Examples 28 to 30, wherein a cross-section of the channel is rectangular, square, triangular, or any combination thereof.

In Example 31, the acoustic transducer device of any one of Examples 28 to 31, wherein the recess includes an opening, configured to allow sound waves to pass from outside the acoustic chamber into the front volume; and wherein the membrane is configured to displace in response to the sound waves in the front volume.

In Example 32, the acoustic transducer device of Example 32, wherein the primary back-volume includes a transducer, configured to generate an electrical signal based on the displacement of the membrane.

In Example 33, the acoustic transducer device of Example 33, wherein the transducer includes an optical sensor.

In Example 34, the acoustic transducer device of any one of Examples 28 to 34, wherein the membrane includes a first side, facing the cap, and a second side, facing the substrate

In Example 35, the acoustic transducer device of any of the Examples 24 to 31 wherein the electromechanical microphone further includes a mirror on the second side of the membrane.

In Example 36, the acoustic transducer device of any one of Examples 33 to 35, wherein the transducer includes a laser.

In Example 37, the acoustic transducer device of Example 36, wherein the laser has a line of sight connection to the mirror.

In Example 38, the acoustic transducer device of any one of Examples 35 to 37, wherein the mirror includes aluminum or gold.

In Example 39, the acoustic transducer device of any one of Examples 35 to 38, wherein a diameter of the mirror is between 10 pm and 120 pm.

In Example 40, the acoustic transducer device of any one of Examples 28 to 39, wherein the membrane has a diameter of 100 pm to 2000 pm.

In Example 41, the acoustic transducer device of Example 40, wherein the membrane has a diameter of 500 pm to 1500 pm.

In Example 42, the acoustic transducer device of any one of Examples 28 to 41, wherein the front volume is sealed to prevent movement of air from the front volume into the primary back-volume or the secondary back-volume.

In Example 43, the acoustic transducer device of any one of Examples 28 to 42, wherein the acoustic chamber further includes a tertiary back-volume, different from the front volume, the primary back-volume, and the secondary back-volume; wherein the channel is a first channel; further including a second channel, configured to join the primary back-volume and the tertiary back-volume.

In Example 44, the acoustic transducer device of any one of Examples 28 to 43, wherein the membrane includes one or more holes.

In Example 45, the acoustic transducer device of Example 44, wherein each of the one or more holes are approximately 3 pm in diameter.

In Example 46, the acoustic transducer device of any one of Examples 28 to 45, wherein the seal includes silicone, an ultraviolet curable epoxy, or a thermally curable epoxy.

In Example 47, the acoustic transducer device of any one of Examples 28 to 46, wherein the membrane includes Silicon Nitride (SiN) or Polycrystalline Silicon (Poly Si).

In Example 48, the acoustic transducer device of any one of Examples 28 to 47, wherein the membrane is generated by plasma-enhanced chemical vapor deposition, low-pressure chemical vapor deposition, a Silane-based coating application, or physical vapor deposition (PVD), such as sputtering.

In Example 49, the acoustic transducer device of any one of Examples 28 to 48, wherein the acoustic chamber defines acoustic compliance of the acoustic transducer.

In Example 50, the acoustic transducer device of any one of Examples 28 to 49, wherein the acoustic transducer is configured as a micro electromechanical microphone.

In Example 51, a method of manufacturing an acoustic transducer device including wherein the acoustic chamber includes: creating a channel in a substrate; disposing a support structure on a substrate, wherein at least part of the support structure is disposed over the channel; disposing a membrane on the support structure; disposing a seal on the membrane or the support structure; disposing a cap on the substrate, wherein the cap defines an acoustic chamber as a volume between the substrate and the cap; wherein a front volume is defined at least by the membrane, the seal, and the cap; and a primary back-volume is defined at least by the membrane, the support structure, and the substrate; wherein the acoustic chamber further includes a secondary back-volume, different from the front volume or the primary back- volume; and wherein the channel connects the primary back volume to the secondary back volume.

In Example 52, the method of manufacturing an acoustic transducer device of Example 51, wherein the channel is a trench, and the trench is in the substrate.

In Example 53, the method of manufacturing an acoustic transducer device of Example 52, wherein the channel is a trench, and the trench is in the substrate, beneath the support structure.

In Example 54, the method of manufacturing an acoustic transducer device of any one of Examples 51 to 53, wherein the channel is at least 50 pm high.

In Example 55, the method of manufacturing an acoustic transducer device of any one of Examples 51 to 54, wherein a cross-section of the channel is rectangular, square, triangular, or any combination thereof.

In Example 56, the method of manufacturing an acoustic transducer device of any one of Examples 51 to 55, wherein the cap includes an opening, configured to allow sound waves to pass from outside the acoustic chamber into the front volume; and wherein the membrane is configured to displace in response to the sound waves in the front volume.

In Example 57, the method of manufacturing an acoustic transducer device of Example 56, further including arranging a transducer in the primary back-volume, wherein the transducer is configured to generate an electrical signal based on the displacement of the membrane.

In Example 58, the method of manufacturing an acoustic transducer of Example 57,wherein the transducer includes an optical sensor.

In Example 59, the method of manufacturing an acoustic transducer device of any one of Examples 51 to 58, wherein the membrane includes a first side, facing the cap, and a second side, facing the substrate

In Example 60, the method of manufacturing an acoustic transducer device of any one of Examples 51 to 59, further including arranging a mirror on the second side of the membrane.

In Example 61, the method of manufacturing an acoustic transducer device of any one of Examples 58 to 60, wherein the transducer includes a laser.

In Example 62, the method of manufacturing an acoustic transducer device of Example 61, wherein the laser has a line of sight connection to the mirror.

In Example 63, the method of manufacturing an acoustic transducer device of any one of Examples 60 to 62, wherein the mirror includes aluminum or gold.

In Example 64, the method of manufacturing an acoustic transducer device of any one of Examples 60 to 63, wherein a diameter of the mirror is between 10 pm and 120 pm.

In Example 65, the method of manufacturing an acoustic transducer device of any one of Examples 51 to 64, wherein the membrane has a diameter of 100 pm to 2000 pm.

In Example 66, the method of manufacturing an acoustic transducer device of Example 65, wherein the membrane has a diameter of 500 pm to 1500 pm.

In Example 67, the method of manufacturing an acoustic transducer device of any one of Examples 51 to 66, wherein the front volume is sealed to prevent movement of air from the front volume into the primary back-volume or the secondary back-volume.

In Example 68, the method of manufacturing an acoustic transducer device including: forming a recess in a substrate; arranging a chip over the recess, and wherein the chip includes a first side, facing toward the recess, and a second side, opposite the first side, and defines an acoustic chamber as a volume between the recess and the chip; and arranging a support structure within the recess, on the first side of the chip; arranging a membrane on the support structure; arranging a seal in the recess on the membrane or the support structure; arranging a cap on the substrate and over the chip, wherein the acoustic chamber includes: a front volume defined at least by the membrane, the seal, and the recess; and a primary back-volume defined at least by the membrane, the support structure, and the chip; and a secondary back-volume, defined at least by the cap, the substrate, and the chip, and different from the front volume or the primary back-volume; further including forming a channel in the substrate or the support structure, wherein the channel joins the primary back-volume and the secondary back-volume.

In Example 69, the method of manufacturing an acoustic transducer device of Example 68, wherein the channel is a trench, and the trench is in the substrate.

In Example 70, the method of manufacturing an acoustic transducer device of Example 68 or 69, wherein the channel is at least 50 pm high.

In Example 71, the method of manufacturing an acoustic transducer device of any one of Examples 68 to 70, wherein a cross-section of the channel is rectangular, square, triangular, or any combination thereof.

In Example 72, the method of manufacturing an acoustic transducer device of any one of Examples 68 to 71, wherein the recess includes an opening, configured to allow sound waves to pass from outside the acoustic chamber into the front volume; and wherein the membrane is configured to displace in response to the sound waves in the front volume.

In Example 73, the method of manufacturing an acoustic transducer device of Example 72, further including arranging a transducer in the primary back-volume, wherein the transducer is configured to generate an electrical signal based on the displacement of the membrane.

In Example 74, the method of manufacturing an acoustic transducer device of Example 73, wherein the transducer includes an optical sensor.

In Example 75, the method of manufacturing an acoustic transducer device of any one of Examples 68 to 74, wherein the membrane includes a first side, facing the cap, and a second side, facing the substrate

In Example 76, the method of manufacturing an acoustic transducer device of any of the Examples 68 to 75 wherein the electromechanical microphone further includes a mirror on the second side of the membrane.

In Example 77, the method of manufacturing an acoustic transducer device of any one of Examples 73 to 75, wherein the transducer includes a laser.

In Example 78, the method of manufacturing an acoustic transducer device of Example 76, wherein the laser has a line of sight connection to the mirror.

### LIST OF REFERENCE SIGNS

100 Acoustic transducer
102 Printed Circuit Board/Substrate
104 Cap/Housing
106 Support Structure/Membrane Die
108 Membrane
110 Seal
112 Front Volume
114 Primary Back-Volume
116 Secondary Back-Volume
118 Channel
120 Acoustic Port
122 Light Source
124 Photodiode/Photodiode Chip
126 Metallization layer
128 Mirror
130 Integrated Circuit/Chip
132 Digital Die Attach (e.g. flipchip or wire bonding)
134 Surface Mounted Device
136 Solder Ball Array
138 Integrated Photodiode
140 Through-Silicon Via (TSV)
142 Recess
1002 Substrate
1030 Chip
1004 Cap
1006 Support structure
1008 Membrane
1010 Seal
1012 Font volume
1014 Primary back-volume
1016 Secondary back-volume

What is claimed is:

1. An acoustic transducer device comprising:
a substrate; and
a cap, arranged on the substrate, and defining an acoustic chamber as a volume between the substrate and the cap;
wherein the acoustic chamber comprises:
a support structure, disposed on the substrate; and
a membrane, disposed on the support structure;
a seal, disposed between the cap and the membrane or the support structure;
a front volume defined at least by the membrane, the seal, and the cap; and
a primary back-volume defined at least by the membrane, the support structure, and the substrate; and
a secondary back-volume, different from the front volume or the primary back-volume;
the acoustic transducer device further comprising a channel in the substrate or the support structure, wherein the channel joins the primary back-volume and the secondary back-volume.

2. The acoustic transducer device of claim 1, wherein the channel is a trench, and the trench is in the substrate.

3. The acoustic transducer device of claim 2, wherein the channel is a trench, and the trench is in the substrate, beneath the support structure.

4. The acoustic transducer device of claim 1, wherein the channel is in the support structure.

5. The acoustic transducer device of claim 1, wherein the channel is at least 50 pm high.

6. The acoustic transducer device of claim 1, wherein the cap comprises an opening configured to allow sound waves to pass from outside the acoustic chamber into the front volume; and wherein the membrane is configured to displace in response to the sound waves in the front volume.

7. The acoustic transducer device of claim 6, wherein the primary back-volume comprises a transducer configured to generate an electrical signal based on the displacement of the membrane.

8. The acoustic transducer device of claim 7, wherein the transducer comprises an optical sensor.

9. The acoustic transducer device of claim 1, wherein the membrane comprises a first side, facing the cap, and a second side, facing the substrate.

10. The acoustic transducer device of claim 9, wherein the acoustic transducer device further comprises a mirror on the second side of the membrane.

11. The acoustic transducer device of claim 8, wherein the transducer comprises a laser, and wherein the laser has a line of sight connection to the mirror.

12. The acoustic transducer device of claim 8, wherein a diameter of the mirror is in a range between 10 pm and 120 pm.

13. The acoustic transducer device of claim 12, wherein the membrane has a diameter in a range of between 500 pm to 1500 pm.

14. The acoustic transducer device of claim 1, wherein the acoustic chamber further comprises a tertiary back-volume, different from the front volume, the primary back-volume, and the secondary back-volume; wherein the channel is a first channel;
wherein the acoustic transducer further comprises comprising a second channel configured to join the primary back-volume and the tertiary back-volume.

15. The acoustic transducer device of claim 1, wherein the seal comprises silicone, an ultraviolet curable epoxy, or a thermally curable epoxy.

16. The acoustic transducer device of claim 1, wherein the acoustic transducer is configured as a micro electromechanical microphone.

17-23. (canceled)

24. An acoustic transducer device comprising:
a membrane, comprising a first side and a second side, opposite the first side;
a front volume defined at least by the first side of the membrane;
a primary back-volume defined at least by the second side of the membrane; and
a secondary back-volume, different from the front volume or the primary back-volume;
the acoustic transducer further comprising a channel, joining the primary back-volume and the secondary back-volume.

25. The acoustic transducer device of claim 24, further comprising a cap and a substrate, wherein the cap is arranged on the substrate defining an acoustic chamber as a volume between the substrate and the cap;
wherein the acoustic chamber comprises the front volume or the secondary back-volume.

26. The acoustic transducer device of claim 24, further comprising a substrate and a support structure, disposed on the substrate;
wherein the channel is in the substrate or the support structure.

27. The acoustic transducer device of claim 24, wherein the channel is configured as a trench.

28. (canceled)
